(19) United States
(12) Patent Application Publication
(10) Pub. No.: US 2021/0394191 A1
(43) Pub. Date: Dec. 23, 2021

(54) UNIVERSAL STAND FOR HOLDING CAPILLARY AND TRANSFER PIPETTES

(71) Applicant: ANALYTICAL DIAGNOSTIC SOLUTIONS, INC., Mt. Laurel, NJ (US)

(72) Inventors: Robert HARPER, Mount Laurel, NJ (US); Richard Arthur SPINDEL, Woodland Hills, CA (US)

(21) Appl. No.: 17/355,742

(22) Filed: Jun. 23, 2021

Related U.S. Application Data
(60) Provisional application No. 63/042,667, filed on Jun. 23, 2020.

(51) Int. Cl. B01L 9/00; B01L 3/02

(52) U.S. Cl. CPC B01L 9/54; B01L 3/022

(57) ABSTRACT

A universal stand for horizontally holding single use capillary action and/or transfer pipettes is provided.

This patent application claims the benefit of priority from U.S. Provisional Application Ser. No. 63/042,667, filed Jun. 23, 2020, teachings of which are incorporated herein by reference in their entirety.

### BACKGROUND

Capillary action tubes, commonly referred to as single action capillary or transfer pipettes are used for sampling a multitude of liquids including, but not limited to biological samples such as blood, serum and plasma. Also referred to as transfer pipettes, they are widely used in laboratories and for blood sampling, blood culture and urine analysis.

The pipette is a fixed volume, one-piece single plastic tube generally made of durable low-density polyethylene plastic that allows you to collect and dispense liquid samples. Capillary action fills the tube easily or picks up the sample without any bulbs or dispensers. Once filled, the liquid sample can be dispensed easily on to a test strip or a microscope slide by pinching the bulb on top or by pinching an unfilled portion of the tube.

Most pipettes have a built-in pipette bulb at the top which allows for controlled drawing and dispensing of blood or other liquids in drop form. However, when the pipettes are held vertically for too long or when the tip is inadvertently contacted with a surface, spillage or leakage of the liquid sample can occur.

Further, for heel-stick or finger-stick blood samples of volumes of more than 5 microliters, a patient typically has to “milk” the finger or heel which can require either an additional individual to hold the capillary tube or transfer pipette or the patient to place the capillary or transfer pipette on a clean flat surface.

Various vertical and horizontal stands and racks for capillary action pipettes have been disclosed.

### SUMMARY

An aspect of the present invention relates to a universal stand for holding a single use capillary action and/or transfer pipette. The stand comprises a base and a body extending upward from the base with a top, a bottom and two sides. The stand further comprises a recess in the top of the body sized for horizontal holding of a single Use capillary action and/or transfer pipette without any spillage of any liquid in the single use capillary action and/or transfer pipette. In addition, the stand comprises an access hole extending through the two sides of the body sized so a user can squeeze a bulb of any single use capillary action and/or transfer pipette held by the universal stand from either the top or bottom or both the top and bottom of the body of the stand.

In one nonlimiting embodiment, the recess of the universal stand is shaped and sized with a first portion which fits a bulb of a single use capillary action and/or transfer pipette and a second portion which fits part of the capillary tube of the single use capillary action and/or transfer pipette extending from the bulb.

In one nonlimiting embodiment, the universal stand is sized so that a tip of a single use capillary action and/or transfer pipette held by the stand extends horizontally away from the stand.

### BRIEF DESCRIPTION OF THE FIGURES

FIGS. 1A, 1B and 1C show a top side view of the universal stand without (FIG. 1A) and with (FIG. 1C) a single use transfer pipette (FIG. 1B) placed in the recess of the stand.

FIGS. 2A and 2B show a top view of the universal stand without (FIG. 2A) and with (FIG. 2B) a single use transfer pipette placed in the recess of the stand.

FIGS. 3A and 3B show a side view of the universal stand without (FIG. 3A) and with (FIG. 3B) a single use transfer pipette placed in the recess of the stand.

FIGS. 4A and 4B show a side end view of the universal stand without (FIG. 4A) and with (FIG. 4B) a single use transfer pipette placed in the recess of the stand.

### DETAILED DESCRIPTION

Disclosed herein is a universal stand for horizontal holding of a single use capillary action and/or transfer pipette. The stand provides for hands free-collection of liquid samples such as, but not limited to, blood and other biological solutions. The design provides for horizontal holding of the pipette, thus allowing the capillary action and/or transfer pipette to be filled and held until sample transfer without the liquid sample leaking or spilling.

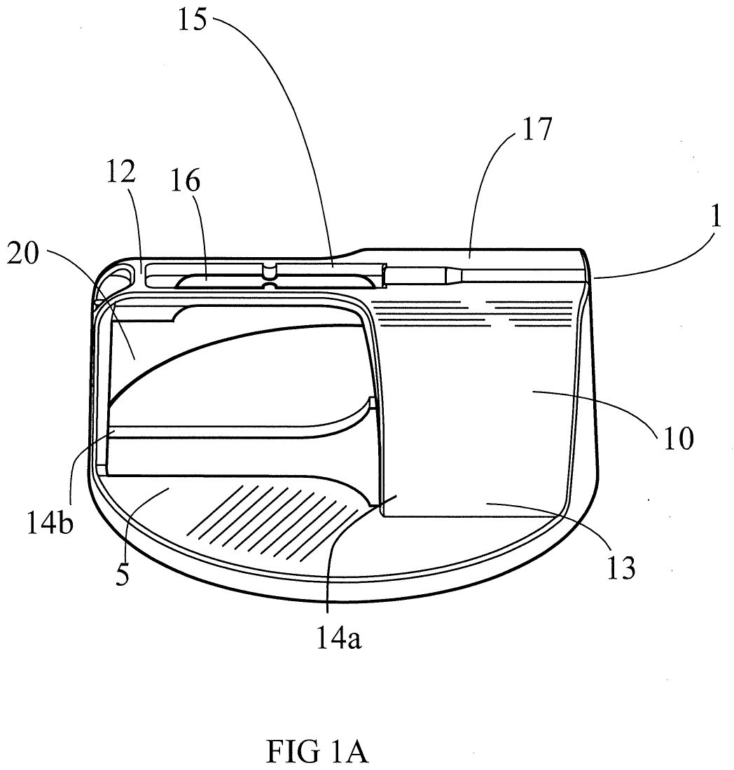

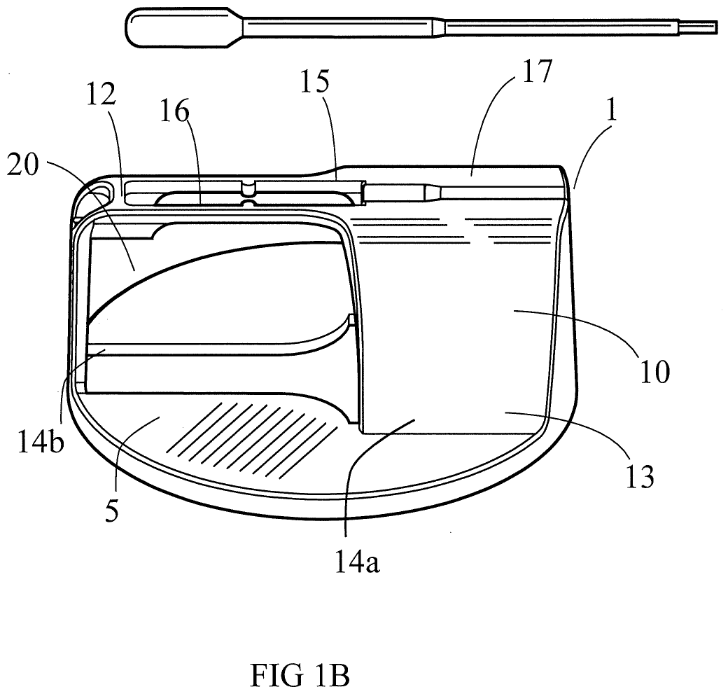

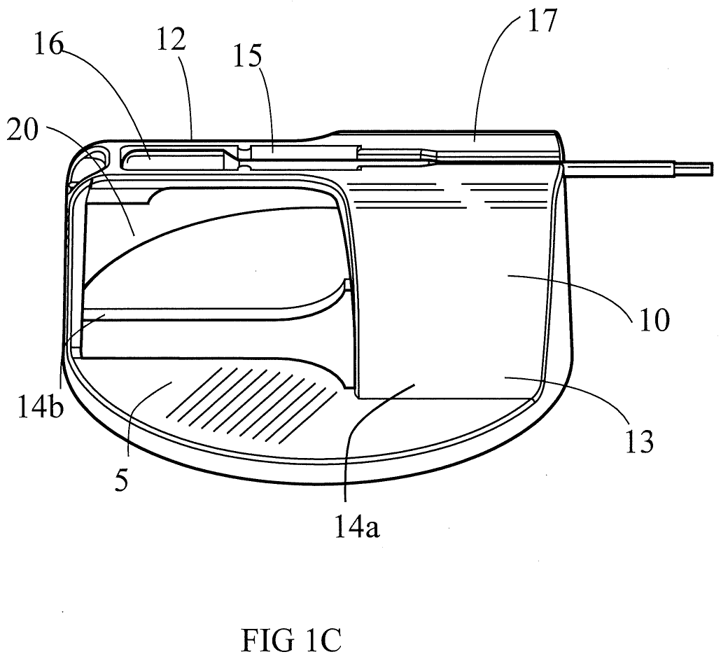

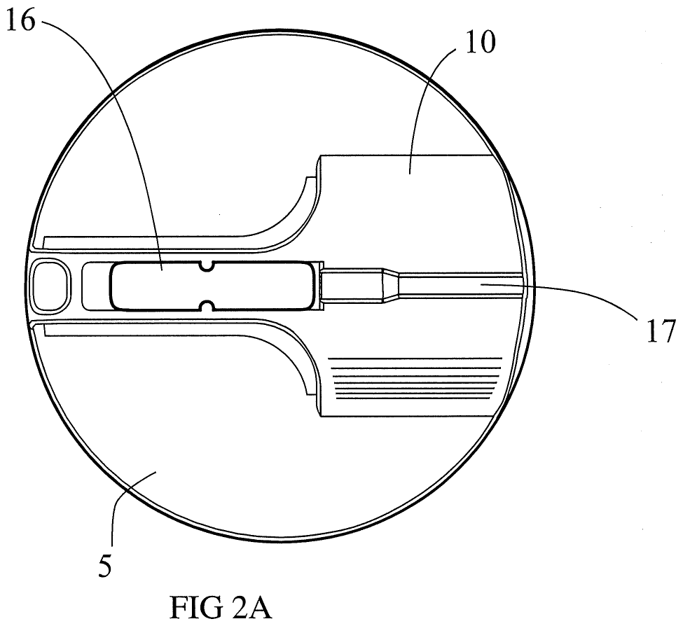

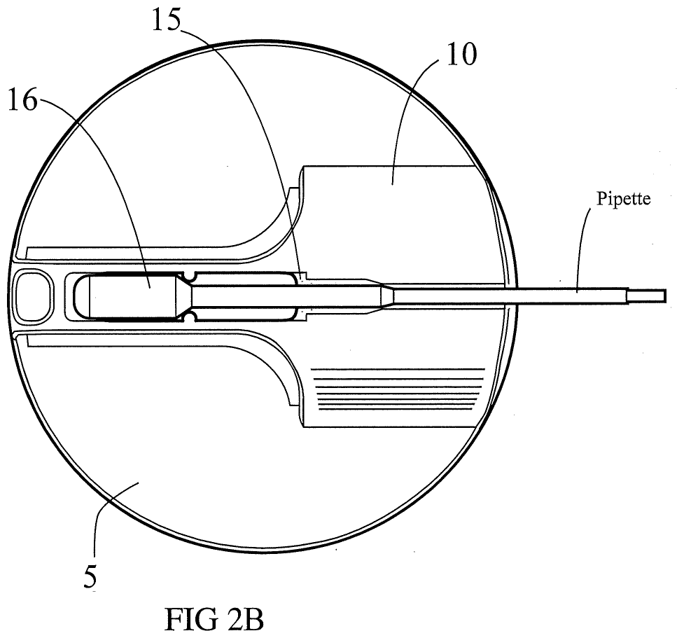

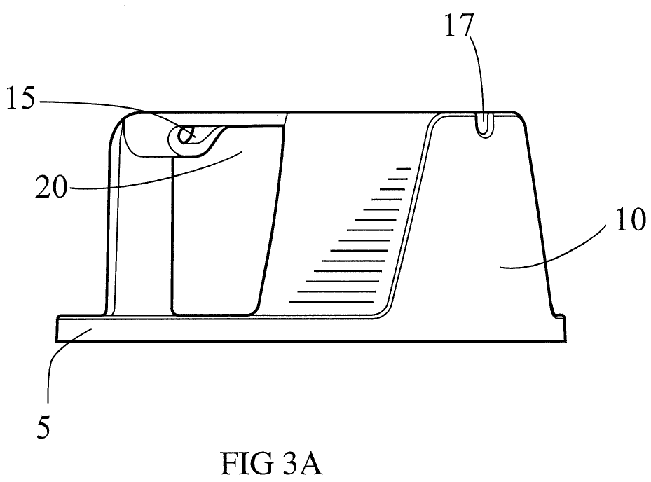

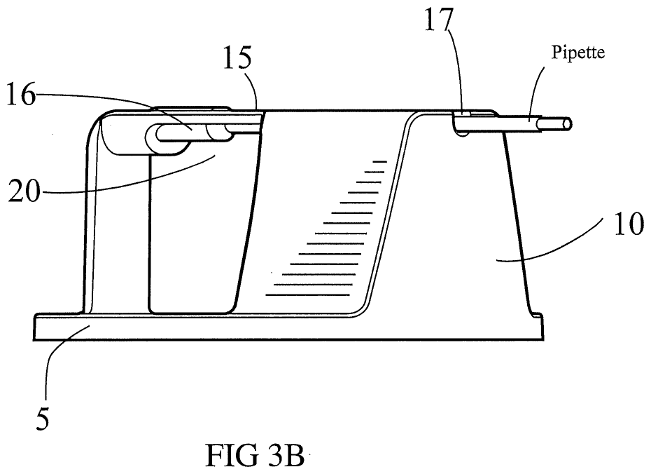

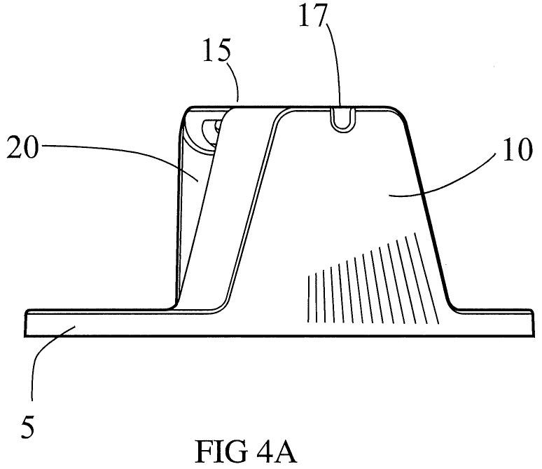

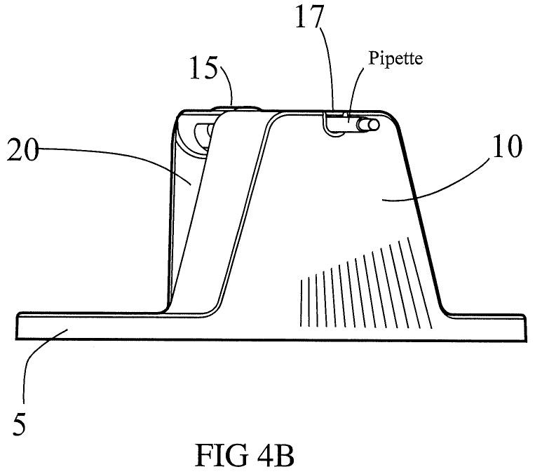

As shown in FIGS. 1A through 4B, the universal stand 1 comprises a base 5 and a body 10 extending upward from the base 5 with a top 12, a bottom 13 and two sides 14a, 14b.

In one nonlimiting embodiment, the base and body are molded from a polymer.

In one nonlimiting embodiment, the base and the body of the stand are molded as a single unit.

In another nonlimiting embodiment, the base and body are molded separately and the bottom of the body fits into the molded base.

Nonlimiting examples of polymeric materials from which the base and bottom may be comprised of include nylon (polyamide), acrylic, polycarbonate, polyoxymethylene(POM), polystyrene (PS), acrylonitrile butadiene styrene (ABS), polypropylene (PP) and polyethylene (PE).

In one nonlimiting embodiment, the polymer can withstand sterilization.

In another nonlimiting embodiment, the universal stand is 3D printed or prepared via stereolithography (SLA) or selective laser sintering (SLS).

As shown in FIGS. 1A through 4B, the stand further comprises a recess 15 in the top 12 of the body 10 sized for horizontal holding of a single use capillary action and/or transfer pipette without any spillage of any liquid in the single use capillary action and/or transfer pipette. The recess is preferably sized to hold capillary action and/or transfer pipettes holding 5 to 50 μL of sample. The recess is preferably contoured to keep the capillary action and/or transfer pipette from sliding laterally out of the stand.

In one nonlimiting embodiment, the recess 15 comprises a first portion 16 sized and shaped to hold or fit the bulb of a single use capillary and transfer pipette and a second portion 17 sized and shaped to hold or fit a portion of a capillary tube of the single use capillary and transfer pipette extending from the bulb. Due to the flexible nature of the pipette bulb, this configuration allows for the stand to grasp the pipette via its bulb thereby stabilizing the capillary action and/or transfer pipette.

In addition, the stand 1 comprises an access hole 20 extending through the two sides 14a, 14b of the body 10 sized so a user can squeeze the bulb of any single use capillary and transfer pipette held by the universal stand 1 from either the top 12 or bottom 13 or both the top 12 and bottom 13 of the body 10 of the stand 1. This design of the stand with the recess and access hole permits almost 360° access to the bulb of the capillary action and/or transfer pipette for squeezing of the bulb of the capillary action and/or transfer pipette as well as removing of the capillary action and/or transfer pipette from the stand.

As shown in FIGS. 1C, 2B, 3B and 4B, the stand and recess are sized so that the tip of the single use capillary action and/or transfer pipette held by the universal stand extends horizontally away from the universal stand.

The recess and access hole of the stand allow for easy placement of a capillary action and/or transfer pipette and transfer of any sample to test strip or microscope slide, followed by removal of the capillary and transfer pipette. Users can easily rest and/or leave the sample filled capillary action and/or transfer pipette in the stand while preparing other parts of the analysis without the worry of sample spills or leakage.

Further, hands-free holding of the capillary action and/or transfer pipette by the stand in a horizontal position with the tip extending horizontally away from the stand and at a height high enough off the table top or floor where the stand is placed to permit safe and clean access to a finger or heel from many different angles allows for a user collecting a finger-stick or heel-stick blood sample to properly clean the sample site prior to sticking, place their stuck finger or heel against the opening of the pipette easily and cleanly for sample collection without potential contamination from surface or additional contact, “milk” his/her finger or heel if needed to fill the capillary or pipette, and/or clean and bandage his or her finger or heel after sampling. Thus, the universal stand minimizes potential sample contamination without compromising sample volume or sample integrity.

What is claimed is:

1. A universal stand for holding a single use capillary action and/or transfer pipette, said stand comprising:
a base; and
a body extending upward from the base with a top, a bottom and two sides, said body further comprising a recess in the top sized for horizontal holding of a single use capillary action and/or transfer pipette without spillage or contamination of any liquid in the single use capillary action and/or transfer pipette and an access hole extending through the two sides sized so a user can squeeze a bulb of any single use capillary and transfer pipette held by the universal stand from the top and bottom of the body and/or easily remove the capillary action and/or transfer pipette.

2. The universal stand of claim 1 wherein the recess comprises a first portion sized to fit a bulb of a single use capillary and transfer pipette and a second portion sized to fit a portion of a capillary tube of the single use capillary action and/or and transfer pipette.

3. The universal stand of claim 1 sized so that a tip of a single use capillary action and/or transfer pipette held by the universal stand extends horizontally away from the universal stand allowing a user to directly contact the tip of capillary action and/or transfer pipette thereby minimizing sample contamination.

4. The universal stand of claim 1 wherein the base and the body are a single molded polymeric piece.

5. The universal stand of claim 1 wherein the base and body are molded separately and the bottom of the body fits into the molded base.
